(19) United States
(12) Patent Application Publication
(10) Pub. No.: US 2014/0118522 A1
(43) Pub. Date: May 1, 2014

(54) Dance learning system using a computer

(71) Applicant: Josh Heath Zuniga, Frisco, TX (US)

(72) Inventor: Josh Heath Zuniga, Frisco, TX (US)

(21) Appl. No.: 13/666,921

(22) Filed: Nov. 1, 2012

(51) Int. Cl. H04N 5/262

(52) U.S. Cl. CPC H04N 5/2621
USPC 348/77

(57) ABSTRACT

The invention describes an interactive dance learning tool for novice as well as professional dancers, using interactive video based tutorials. The tool comprises software using which dancing steps can be taught to the dancer. Further, the tool also helps capturing dancing the steps of the dancer and his/her partner. It allows shadowing or highlighting the dancer's steps in accordance with the partner's steps, so that the dancer can clearly see its moves. The tool may use a gesture recognition technique and a webcam to capture the dancer's movement. The tool may also use an avatar to be placed along with the dancer to make him/her learn correct steps. The software applies image/video processing techniques and algorithms to extract user's movements. The tool helps a user to learn dance in privacy and without requiring a professional instructor. The tool also provides feedback to the learner based on alerts or notification, which is a voice or visual alert.

### FIELD OF THE INVENTION

The invention is generally related to the computer based learning and in particular related to the interactive dance learning method and system using a video camera by capturing the images of the learner.

### BACKGROUND OF THE INVENTION

A web camera or a video camera system consists of a photographic camera with software that runs on a personal computer to periodically upload an image from the camera to a web page. The basic purpose of a web camera system is to post a reasonably live picture on a user-specified web page. Many webcam systems upload images on a periodic basis; for example, uploading an image once per hour.

Computer based learning has been in use for almost a decade now. The method and systems for computer based learning are used to teach the skills to both novice and experts. With the advent of internet, audio-visual means, high quality camera systems and enhanced video process algorithms, the learning methods have improved in yield and performance. The computer based learning systems are interactive, smart and controlled way of teaching supported by modern computing technologies.

Teaching dance or other form of performing art has been a passion among youth for past many decades. There are numerous dance forms, which are practiced across the globe. A few of the dance forms, especially popular in the United States are, Hip-Hop, Rock and Roll, Cha-Cha-Cha, Jazz dance, Turkey Trot, Country dance, Charleston and so on. These dance forms are learnt in many ways, including live classrooms, through personal dance trainers or using video recorded dance classes. These ways are traditional and time consuming, yet used by most of the learners.

There has been advancement in recent years in the way people learn dancing using interactive means. Many innovations in this field have brought computer implemented methods which use ergonomic ways to record the motion and use it for training purposes. The U.S. Pat. No. 6,981,876 assigned to Accelerized Golf describes the use of a camera systems to capture successive images of a person's movement and apply image processing techniques to simulate the action on a computer screen. Such a method can be used for dance learning as well. However, the technique described does not include a teaching instruction used to teach the dance steps to a leaner.

The U.S. patent application 20090258703 by Brunstetter describes a technique for motion assessment of a person using a game controller, such as Wii from Nintendo, Inc. However the patent is limited to describe such a system being used in multiplayer gaming environment, and not for actual training of dance sequence to a user.

Similarly, the U.S. patent application 201000035688 by MN networks illustrates an electronic game system which detects a user's foot movement. Such a system can be used to capture the dance steps of a person and record the movement for further training. However, the system does not help a novice to learn the dance steps in an interactive manner.

There are some dance learning systems, such as Zumba Wii, which uses a Wii remote belt to detect the motion of a dancer and teach them dance interactively using an avatar. However, the Zumba Wii system is dependent on the motion sensing technique of the controller system and only approximates the learner's movements.

An existing technology developed by Sixense Entertainments is for motion control. Sixense MotionCreator is a software application that delivers motion game play for virtually any published PC game. This technology is based on the Razer Hydra hardware which has grading motion sensing controllers. The controllers can intuitively track the gesture and control the game using the gestures of the player. The system however, does not include the sensing of the motions from various body parts to emulate the motion on the screen.

Therefore, there is a clear need in the market to introduce a system which can emulate the dancer's footsteps using a camera and teach the leaner the dance steps interactively, without going out for a real classroom.

### BRIEF DESCRIPTION OF DRAWINGS

FIG. 1 illustrates the components of the system in accordance with the preferred embodiment

FIG. 2 illustrates a flow chart depicting the working of the system.

### DETAILED DESCRIPTION

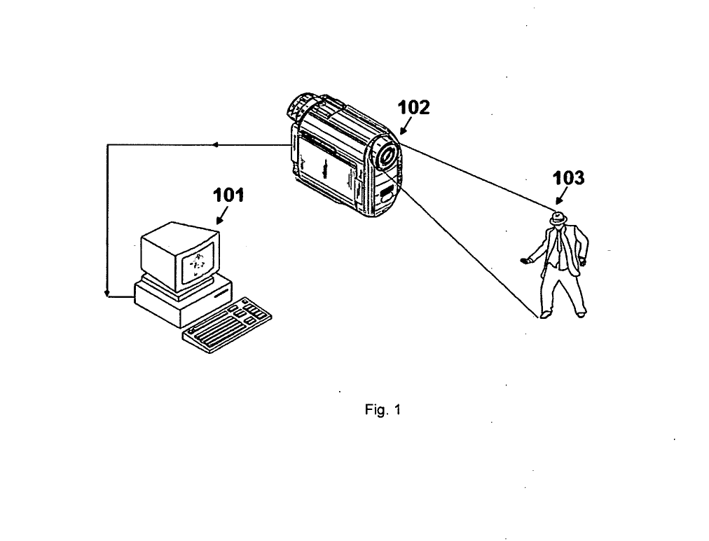

FIG. 1 illustrates a system in accordance with the preferred embodiment of the invention. The system comprises a computer system 101 which could be connected to a network, such as internet. The computer system is attached with a camera 102, such as a video camera. In another embodiment the video camera could be a web camera, digital camera or any other video or image capturing camera through which a photograph or video of an object, such as a dance, can be captured. The dancer 103 is captured using the camera 102, and the captured images are transferred to the computer system 101 for further processing.

The computer system 101 comprises software which is capable of processing the captured image or video. The software also has a module which has pre-recorded dance sequences for teaching purposes. The captured images are converted by the software to digital avatars, which are used to superimpose over the pre-recorded dance sequence images. Another module of the software helps to calculate the difference between the movements of the dancer's moves and the pre-recorded dance sequence moves, so that a learner can see how much variation are there in his/her movements.

The underlying algorithm for detection of motion using a video or web camera is explained in one of the embodiments. In the preferred embodiment, the full body images of a person performing movement in front of the camera are captured at regular intervals. The interval of the capturing of the images depends upon the resolution of the camera or the quality of the video to be recorded. Usually, a frame rate of 24 to 32 is needed for a non-high definition video which would be workable with this invention. The difference of movement of the person from current frame to the previous frame is calculated and the pixel difference is calculated to identify the threshold of change in the image and movement.

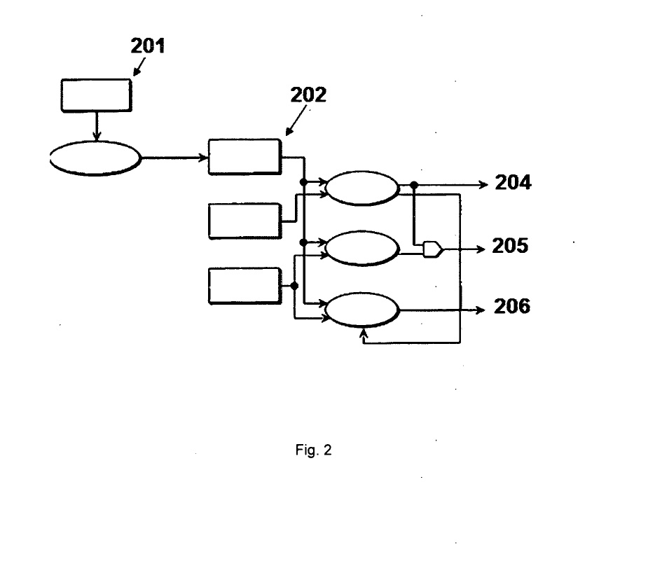

FIG. 2 illustrates a conceptual diagram of various detecting algorithms utilized in accordance with one embodiment of the present invention. A camera outputs a color image, which is then converted to a black-and-white (B/W) pixel representation of a current image frame. Three different modes of motion detection are then provided to capture specific types of events. In the basic mode of motion detection, the web camera system selects the most recent image containing motion above a certain threshold. This image represents the candidate image for uploading to the user-specified web server. As previously discussed, the basic mode of motion detection involves a straightforward pixel-by-pixel comparison between a current frame and a previously captured image frame.

Another type of motion detection mode of operation is referred to as the stable motion detection. The stable mode of motion detection is designed to capture persistent changes in a scene, while ignoring relatively simple motions. For example, the stable-change mode of operation is useful in video conferencing applications where the video camera is aimed at a desk or whiteboard where a speaker is placing written subject matter or other objects in front of the camera to facilitate discussion. In such applications, it is useful to capture the notes written on a board, or otherwise presented in front of the camera, while ignoring extraneous motion such as writing on the board, finger pointing, etc. This kind of movement detection is especially useful when the motion of the dancer is to be matched with a background and with a pre-recorded dance sequence avatar to identify the similarity or differences.

In yet another embodiment, a game controller for motion sensing of the dancer is used instead of the camera. The motion sensing game controller could be a Nintendo Wii Remote, Microsoft Kinect, Sixaxis, DualShock3, Move controller (for Sony PlayStations), Sony's Eyetoy or any other contemporary system which has a motion sensing feature. Such a system is easily available in market and can be deployed with ease. They are also simple to use and effective in sensing the movement of a user.

The computer system 101 as shown in the FIG. 1 could be a portable device, cell phone, mobile phone, palm top, iPad or any other computing device which has a processing system and a display system. The software as described above will then be replaced by a mobile application running on the mentioned portable systems.

The forms of dance that are to be captured using the above mentioned system include, but not limited to Ballet, Jazz, Tap, Hip-Hop, Modern, Swing, Contra, Country, Western, Belly, Flamenco, Latin, Classical, Folk, Contemporary, Line, Cakewalk, Cha-Cha-Cha, Charleston, Maxixe, Turkey Trot, Rock N Roll, Clog, Molly, Morris, Long Sword, Rapper, Bourree, Farandole, Menuet, Rigaudon, etc. These dance forms usually take either one of two partners, who can be controlled by the mentioned system using the camera images.

In one of the embodiments, the inventive system will provide dance instructions to teach and train the dancers for a specific choreography. The system can be used as a training system for those who want to learn the dance from scratch. Working with the system will not require any specific skills and a novice user can also use the inventive system to learn dance techniques. The inventive real time feedback mechanism inbuilt in the system for learners make the system more useful compared to the prior art. The inventive system acts as a coach to those who wish to learn any kind of dance form, as described in the previous paragraph. The online system makes it usable remotely and anybody can use the system from any part of the world, as far as the system is connected to a reliable network connection, such as internet.

In another embodiment, the inventive system includes an alert based feedback mechanism, which allows the learners to get a feedback on their performance with an alert or notification. The alert or notification is real time based on the deviation of the learner's performance compared to the standards set by the system for the learner. The alert could be in the form of a voice based or visual alert on the screen. In another embodiment, the notification can also be accessed by the leaner upon completion of a learning/coaching session in the form of a report. The report could be in text, image or video format, comprising the mistakes or deviations by the leaner during the session, and the ways to correct those mistakes.

In yet another embodiment, the inventive system can be used by a professional dance instructor to create the recorded sessions of his/her dance trainings. The recorded sessions of dance sequence can be captured over CD-ROM or DVD format, to be later distributed or sold. The recorded session of dance could be in executable file format (exe) or Java coded format, to be run on the proprietary software platform. The executable file format can also be converted to popular video formats such as MPEG 4, FLV, DivX, MOV, H.264, JW, etc.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. As an example, the embodiments of the algorithm, software, hardware, computer system, camera can be in various forms and shapes. Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method for learning dance by a user using a networked computer, the method comprising the steps of:
Capturing a sequence of images of a user using a camera;
Creating an avatar using the sequence of images on a screen of the computer;
Playing a recorded dance sequence of an instructor on the screen of the computer;
Superimposing the avatar to the instructor' dance moves to highlight the move difference; and
Indicating the user with the difference in move;
Wherein, the user learns the dance sequence of the instructor by imitating the instructor's dance movements.

2. The capturing of dance sequence according to claim 1, is aided by a game controller which captures the gesture of the user.

3. The game controller according to claim 2, is a Nintendo Wii controller.

4. The game controller according to claim 2, is Kinect.

5. The game controller according to claim 2, is Razer Hydra.

6. The networked computer according to claim 1, is a mobile phone.

7. The networked computer according to claim 1, is a handheld portable device.

8. The networked computer according to claim 1, is connected to internet.

9. The avatar according to claim 1, is a real image of the user.

10. The camera according to claim 1, is a web camera attached to the computer.

11. The indication according to claim 1, further comprises providing an alert to the user based on the deviation of user's performance from the standard.

12. A system for learning the dance by a user, the system comprising:
A camera unit for capturing the images of the dance sequence;
A recording unit for recording the dance sequence and creating a dance avatar;
A player for playing the recorded dance sequence;
A processing unit for matching the dance sequence and calculate the difference of the dance movement, using a matching algorithm.

13. The system according to claim 12, is a computer system.

14. The camera unit according to claim 12 is attached to the recording and processing unit using computer network.

15. The camera unit according to claim 12, is a video camera.

16. The camera unit according to claim 12, is a web camera.

17. The processing unit according to claim 12, indicates if there is any difference between the dance sequence of the user and avatar, based on the result of the matching algorithm.
